(19) United States
(12) Patent Application Publication
(10) Pub. No.: US 2006/0130387 A1
(43) Pub. Date: Jun. 22, 2006

(54) Fish strike alarm apparatus

(76) Inventor: Stephen B. Shumansky, New York Mills, MN (US)

Correspondence Address: KRAMM LAW, P.O. BOX 20726, BLOOMINGTON, MN, 55420-0726, US

(21) Appl. No.: 11/020,859

(22) Filed: Dec. 22, 2004

(51) Int. Cl. A01K 97/12

(52) U.S. Cl. 43/17

(57) ABSTRACT

A fish strike alarm apparatus comprises a housing, an electrical circuit, a power source, an alarm activated when the electrical circuit is completed and a fish strike detector that comprises a retaining member coupled to the housing, and a biased micro switch. The biased micro switch is configured in a normally closed setting and positioned a predetermined distance from the retaining member that causes the electrical circuit to be completed when a fish strike is detected.

### BACKGROUND AND SUMMARY

The present invention relates generally to fishing devices. More particularly, the invention relates to fishing alarms utilizing a limit switch for detection.

Among conventional electrical alarm devices used with fishing equipment are devices that are battery powered circuits with signaling means and detection devices housed in metal or plastic. When used outdoors and exposed to the weather elements including extreme cold, some of those alarm devices and the detection mechanisms therein may fail to function as well as desired under typical use and handling. For example, some metal electrical alarm boxes sitting out in the rain can rust or leak and then short out or cause a shock. When ice fishing in bitter cold between −20° C. and −40° C., some detection mechanisms present difficulties including an undesirable relatively heavy operating force and some plastic housing if mishandled or dropped may crack or shatter.

One of the objects of the present invention is to provide an improved fish alarm having a detection mechanism that works with a relatively light operating force in bitter cold between −20° C. and −40° C. Another object is to provide an improved housing that is less susceptible to crack or shatter when dropped under those adverse conditions. Yet another object is to provide a fish alarm with a housing that when sitting out in the rain does not rust, leak or conduct a shock.

An apparatus is provided for a fish strike alarm apparatus that comprises a housing, an electrical circuit connected to the housing, and a power source connected to the housing. An alarm connected to the electrical circuit is activated when the electrical circuit is completed. A fish strike detector is connected to the housing and comprises a retaining member coupled to the housing, and a biased micro switch. The biased micro switch is positioned a predetermined distance from the retaining member that causes the electrical circuit to be completed when a fish strike is detected.

Another form of the fish strike alarm apparatus comprises a housing, an electrical circuit connected to the housing, a power source, and an alarm connected to the electrical circuit that is activated when the electrical circuit is completed. The alarm comprises an audible signal and a visual signal. An audible two-way switch control has a first position to enable the audible signal and a second position to disable the audible signal. A visual two-way switch control provides a first position to enable the visual signal and a second position to disable the visual signal. A fish strike detector comprises a backboard coupled to the housing, and a snap-action switch positioned a predetermined distance from the retaining member. The snap-action switch is configured in a normally closed position that causes the electrical circuit to be completed when a fish strike is detected.

### BRIEF DESCRIPTION OF THE DRAWINGS

The present invention will now be described, by way of example, with reference to the accompanying drawings, in which:

FIG. 1 is a perspective view of the fish strike alarm apparatus.

FIG. 2 is an electrical schematic view of the fish alarm circuit.

### DETAILED DESCRIPTION

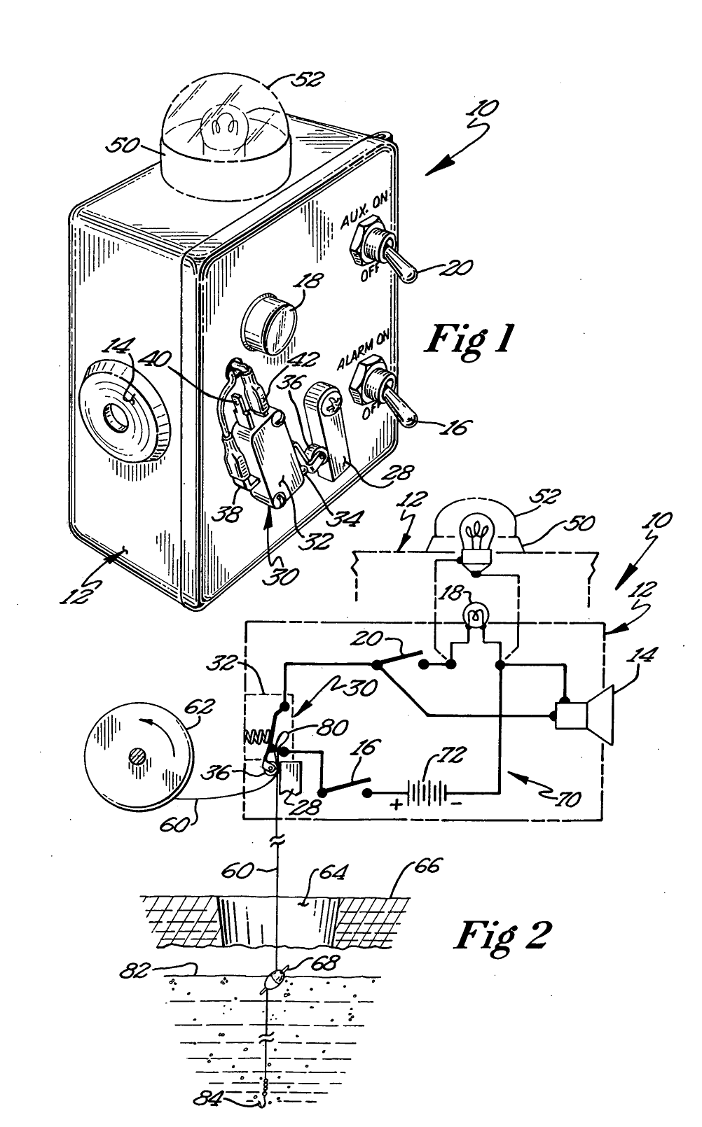

A preferred embodiment of the present invention is illustrated by way of example in FIGS. 1-2. With specific reference to FIG. 1, an improved fish strike alarm apparatus 10 is shown to comprise a housing 12, an electrical circuit connected to the housing 12, a power source, an alarm connected to the electrical circuit that is activated when the electrical circuit is completed and a fish strike detector.

The housing 12 which is in the form of a cube like box having an anterior side detachable from the rest of the housing 12 to provide access to the interior of the housing 12. Preferably the housing 12 is made of a rubber material for a number of advantages. When sitting out in the rain it does not rust or leak and then short out or cause a shock. When outside ice fishing in bitter cold between −20° C. and −40° C., the housing 12 if mishandled or dropped resists cracking or shattering.

The power source in this embodiment is a battery 72. The alarm comprises an audible signal such as speaker 14 and a visual signal such as indicator light 18 or flashing strobe light 52.

An audible two-way switch control 16 has a first position to enable the audible signal and a second position to disable the audible signal. A visual two-way switch control 20 provides a first position to enable the visual signal and a second position to disable the visual signal.

The fish strike detector comprises a retaining member such as a backboard 28 coupled to the housing 12, and a biased micro switch positioned a predetermined distance from the retaining member. The backboard 28 has a rectangular shape and is pivotally mounted to the anterior side of the housing 12 for adjusting the desired predetermined distance from the backboard 28 to the biased micro switch. The backboard 28 can be made of nonconductive as well as conductive materials. For example, the backboard 28 can be made of nonconductive plastic or rubber material because the backboard 28 does not function as an electrically conductive contact for receiving electrical flow from the snap-action switch 30. The backboard 28 functions as one of two opposing support structures with the other structure being the snap-action switch 30, for temporarily supporting a loop 80 of fish line 60 until a fish strikes the hook 84. Preferably the backboard 28 is made of stainless steel for purposes of preventing corrosion.

The biased micro switch may be a limit switch such as a miniature snap-action switch 30. The snap-action switch 30 is configured in a normally closed position that causes the electrical circuit to be completed when a fish strike is detected. Consequently, when setting the fish strike alarm apparatus, a line 60 is inserted between the backboard 28 and the auxiliary actuator 36 of the snap-action switch 30. The predetermined distance between the snap-action switch 30 and the backboard 28 is the distance sufficient to provide two positions of the auxiliary actuator 36. In the alarm setting first position, a line 60 is placed against the backboard 28 so as to cause the auxiliary actuator 36 to be retracted which depresses the actuating button 34 into the case 32 of the miniature snap-action switch 30. As a result, the snap-action switch 30 in a normally closed position causes the electrical circuit to be open and disabled. In the alarm triggering second position, when a fish strikes the hook 84, the line 60 is removed from between the auxiliary actuator 36 and the backboard 28 so as to cause the auxiliary actuator 36 to be extended toward the backboard 28 the distance formerly occupied by the line 60 which releases the actuating button 34 out of the case 32 of the miniature snap-action switch 30. Consequently, the snap-action switch 30 in a normally closed position causes the electrical circuit to be completed.

Many forms and lengths of limit switches and components including terminals and actuators can be understood to be contemplated within the scope of this invention. One example of a source for a snap-action switch 30 is model D44LR|RA from Cherry Electrical Products of Pleasant Prairie, Wis. 53158. The snap-action switch 30 has a UL1054 rating of 10A 1/2HP, 125/250VAC.

The snap-action switch 30 achieves a cold weather objective of this invention by having a temperature rating of −40° C. to +85° C. The snap-action switch 30 comprises a thermoplastic polyester case 32, a thermoplastic actuating button 34, a metal auxiliary actuator 36, a silver-plated brass common terminal 38, brass NO and NC terminals 40, 42 and silver alloy contacts. The snap-action switch 30 is configured to a normally closed position.

The snap-action switch 30 accomplishes another object of this invention by providing a relatively light operating force in bitter cold between—20° C. and −40° C. cold weather with an actuator of a standard 285 (Gms) and a light 75 (Gms) maximum operating force. The actuator is a RA actuator type that also has 0.047 inches (1.19 mm) maximum pre-travel, 0.776 inches (19.71 mm) operating point, 0.040 inches (1.02 mm) minimum over travel, 0.010 inches (0.25 mm) maximum movement differential, and 0.810 inches (20.57 mm) actuation length. Actuation lengths can be dimensioned from the centerline of a switch mounting hole.

FIG. 2 is an electrical schematic view of the fish alarm circuit 70. The fish alarm circuit 70 in an indoor environment, consists of a battery 72, audible signal switch 16, a detection switch, a speaker 16, a visual signal switch 20, and an indicator light 18. The detection switch is represented by the snap-action switch 30, or any other mechanism that is used to detect a fish strike. The detection switch closes when the detection apparatus completes the alarming circuit. For example, in the triggered alarm position, when a fish strikes the hook 84, the line 60 is removed from between the auxiliary actuator 36 and the backboard 28 causing the auxiliary actuator 36 to extend toward the backboard 28 which releases the actuating button 34 out of the case 32 of the miniature snap-action switch 30 and then causing the snap-action switch 30 configured in a normally closed position to complete the electrical circuit. In the indoors embodiment of the fish alarm circuit 70, the snap-action switch 30 is connected to the speaker 14 in primary and to the indicator light 18 in auxiliary relationship.

The following description of various embodiments implemented in an operating environment of fishing with a fishing pole or a tip-up indoors is to be construed by way of illustration rather than limitation. This description is not intended to limit the invention or its applications or uses. For example, while various embodiments of the invention are described as being implemented indoors with a fishing reel secured within a fish house, a fishing pole or tip-up, it will be appreciated that the principles of the invention are applicable to implementations operable in other environments. For example, and as described below, in the operating environment of fishing outdoors. The fish alarm circuit 70 in an outdoor environment, consists of mostly the same parts as those used in an indoors environment, namely a battery 72, an audible signal switch 16, a detection switch, a speaker 16, a visual signal switch 20 with the exception that a brighter flashing strobe light 52 is placed on top of the housing 12 in replacement of the indicator light 18. The detection switch is still represented by the snap-action switch 30, or any other mechanism that is used to detect a fish strike. In the outdoors embodiment of the fish alarm circuit 70, the snap-action switch 30 is connected to the speaker 14 in auxiliary and to the strobe light 52 in primary relationship.

The indoor embodiment of the fish strike alarm apparatus 10 can be used with a fishing reel 62 pivotally secured onto the inside of a fish house, a fishing pole or with a tip-up. The fish strike alarm is activated by the snap-action switch 30 and can be set to alert a fisherman when a fish attacks the baited hook 84 by means of only an audible signal or by both a visual signal and an audible signal. With the indoor embodiment, the visual signal is on an auxiliary circuit and is preferably an indicator light 18 having a lamp bulb with a red lens mounted on the anterior face of the housing 12.

| Two-way switch | Both off | Only Audible on | Both on |
|---|---|---|---|
| Aux | off | off | on |
| Alarm | off | on | on |

The outdoor embodiment of the fish strike alarm apparatus 10 can be used with a fishing reel 62 pivotally secured onto the outside of a fish house, a fishing pole or with a tip-up. The fish strike alarm is activated by the snap-action switch 30 and can be set to alert a fisherman when a fish attacks the bait by means of only an audible signal or by both a visual signal and an audible signal. The outdoor embodiment of the fish strike alarm apparatus 10 is similar to the indoor embodiment except that the visual signal is on a primary circuit and preferably the indicator light 18 is replaced with a brighter strobe light 52 on top of the housing 12.

Alternative uses of the fish strike alarm apparatus 10 includes but is not limited to an intruder strike alarm setup around the perimeter of a protection area such as unsecured structures, tent camping, dock leading to boats, a garden or shrubs being eaten at night by deer.

While the present invention has been disclosed in connection with the preferred embodiment thereof, it should be understood that there may be other embodiments which fall within the spirit and scope of the invention as defined by the following claims.

What is claimed is:

1. A fish strike alarm apparatus comprising:
a housing;
an electrical circuit connected to the housing;
a power source connected to the housing;
an alarm connected to the electrical circuit that is activated when the electrical circuit is completed;
a fish strike detector connected to the housing, the fish strike detector comprising:
a retaining member coupled to the housing, and
a biased micro switch positioned a predetermined distance from the retaining member that causes the electrical circuit to be completed when a fish strike is detected.

2. The apparatus of claim 1 wherein the biased micro switch is configured in a normally closed position.

3. The apparatus of claim 1 wherein the biased micro switch is a limit switch.

4. The apparatus of claim 1 wherein the limit switch is a snap-action switch.

5. The apparatus of claim 1 wherein the housing is made of rubber.

6. The apparatus of claim 1 wherein the retaining member is a backboard.

7. The apparatus of claim 6 wherein the backboard is made of an electrically conductible material.

8. The apparatus of claim 6 wherein the backboard is made of an electrically resistant nonconductive material.

9. The apparatus of claim 1 wherein the alarm comprises an audible signal.

10. The apparatus of claim 1 wherein the alarm comprises a visual signal.

11. The apparatus of claim 1 wherein the alarm comprises an audible signal and a visual signal.

12. The apparatus of claim 10 wherein the visual signal is an indicator light.

13. The apparatus of claim 10 wherein the visual signal is a strobe light.

14. The apparatus of claim 9 further comprising an audible two-way switch control having a first position to enable the audible signal and a second position to disable the audible signal.

15. The apparatus of claim 10 further comprising a visual two-way switch control having a first position to enable the visual signal and a second position to disable the visual signal.

16. A fish strike alarm apparatus comprising:
a housing;
an electrical circuit connected to the housing;
a power source connected to the housing;
an alarm connected to the electrical circuit that is activated when the electrical circuit is completed, the alarm comprising an audible signal and a visual signal;
an audible two-way switch control having a first position to enable the audible signal and a second position to disable the audible signal;
a visual two-way switch control having a first position to enable the visual signal and a second position to disable the visual signal; and
a fish strike detector comprising:
a backboard coupled to the housing, and
